(19) United States
(12) Patent Application Publication
(10) Pub. No.: US 2024/0099265 A1
(43) Pub. Date: Mar. 28, 2024

(54) DEVICE AND METHOD FOR THE AUTOMATED IDENTIFICATION OF A PIG THAT IS READY FOR ONWARD TRANSFER

(71) Applicant: BIG DUTCHMAN INTERNATIONAL GMBH, Vechta (DE)

(72) Inventors: Urs Hunziker, Meilen (CH); Maxim Hase, Dinklage (DE); Dennis Engelking, Raddestorf (DE)

(73) Assignee: BIG DUTCHMAN INTERNATIONAL GMBH, Vechta (DE)

(21) Appl. No.: 18/373,602

(22) Filed: Sep. 27, 2023

(30) Foreign Application Priority Data
Sep. 28, 2022 (LU) 502848

(51) Int. Cl. A01K 11/00; A01K 29/00; G06Q 10/0631; G06Q 50/02

(52) U.S. Cl. CPC A01K 11/006; A01K 29/005; G06Q 10/0631; G06Q 50/02

(57) ABSTRACT

A device for the automated identification of a pig that is ready for onward transfer includes a detection unit for the determination of a weight statement of at least one pig, a database with pig-related data, wherein the pig-related data includes statements concerning at least one determined, or determinable, pig, and an evaluation unit configured to generate an onward transfer indicator. The evaluation unit is configured for data exchange with the detection unit and with the database, such that the evaluation unit generates the onward transfer indicator as a function of the determined weight value and as a function of the pig-related data, so as automatically to identify the pig with the onward transfer indicator as being ready for onward transfer.

### CROSS-REFERENCE TO FOREIGN PRIORITY APPLICATION

The present application claims the benefit under 35 U.S.C. §§ 119(b), 119(e), 120, and/or 365(c) and which claims priority to Application No. LU502848 filed Sep. 28, 2022.

### FIELD OF THE INVENTION

The present invention relates to a device for the automated identification of a pig that is ready for onward transfer.

In addition, the present invention relates to a method for the automated identification of a pig that is ready for onward transfer. In addition, the present invention relates to a computer program product, a computer-readable storage medium, a computer-readable data medium, and a data medium signal.

### BACKGROUND OF THE INVENTION

There are systems of known art that enable the selection of pigs that have reached slaughter maturity. In conventional systems and systems of known art, pigs are led over a weighing cell and are sorted out by way of a mechanical routeing system. Mechanical scales and downstream routing control systems are expensive to purchase, and require additional maintenance over the service life of the facility. For example, the routing control system must be checked periodically, and the weighing cell or scales must be maintained continually.

In addition to the mechanical scales, there are camera-based systems of known art, which are set up to estimate the weight of pigs.

For example, a method for the determination of biometric characteristics of vertebrates is of known art from WO 2016/192853, in which a camera system and methods of image processing are used to estimate a weight of a pig on the basis of distinctive points on the body surface of the pigs.

In addition, from WO 2021/170488 a system for the recording of animals is of known art, in which a 3D camera unit and a computer unit are used to determine a weight of the animal, based on the camera image. In addition, WO 2021/170488 provides an output device, which includes a visual element, by means of which, when viewing the at least one animal, data stored for the animal or generated in the computer unit can be displayed in a supportive manner. The visual element can be, for example, a set of augmented or virtual reality spectacles that are worn by a user. The system from WO 2021/170488 is therefore a system that a user, that is to say, a pig transfer operator, can use to display in a visual manner the weight of the pig and other data related to the animal.

However, the problem with such camera-based systems is that the estimation of the weight can be inaccurate, and the camera image, as the only reference variable, can be subject to error. In addition, there are other problems that arise, especially in the case of pig breeding.

In a typical pig production facility, about 10 to 50 pigs are raised per pen (Central Europe typically has half as many animals in the pen as in the rest of the world).

A fattening barn typically has 2,000 to 10,000 animals that are raised in such pens. A pig farm typically has a number of barns. A producer typically owns one or more farms, which in turn are located both in the geographical neighbourhood, and also at greater distances. In comparison to the breeding of cattle and horses, there are considerably more animals per unit area, which makes the selection of the pigs more difficult.

In addition, in pig breeding it is of interest, once a minimum occupancy of a barn has been reached, to transfer all the animals out of the barn so that it can then be disinfected. In the case of horses and cattle, it is possible to turn the animals out onto pasture and clean the barn in the interim period.

Compared to the rearing of calf and cattle, other problems arise in the case of pig breeding. For example, the processes in the agricultural facility have to be much more efficient, because both the yield per animal is lower and the number of animals to be harvested is higher. In addition, the intensity of movement of the animals varies. Some animals move only a little, and lie down a lot. This makes camera-based weight estimation difficult.

The herd behaviour is also different in pigs. Pigs lie together, or partly on top of each other, under certain temperature conditions. This makes the corresponding camera-based weight estimation even more difficult. Furthermore, the yield per animal is low, so that individual animal monitoring, for example, with radio units attached to the animals, is not commercially viable in many cases.

The selection of pigs to be removed from a farm, for example, for slaughter, is also difficult because nowadays more and more relevant requirements of the processors are added to the typical minimum weight criterion. For example, it must be ensured that other criteria are fulfilled in addition to the pure weight specification, such as requirements for the animal feed during weight gain or the animals' exercise areas.

Purely camera-based systems, such as those of known art from WO 2021/170488, do not meet these requirements and problems.

It is therefore the object of the present invention to address one of the above-mentioned problems, to improve the general prior art, or to provide an alternative to what is previously of known art. In particular, a solution is to be provided with which the readiness of a pig to be transferred onward can be determined with certainty. In addition, resources are to be conserved, and the process of onward transferral of the pigs is to be designed more efficiently.

### SUMMARY OF THE INVENTION

In accordance with the invention, a device for the automated identification of a pig that is ready for onward transfer is proposed in accordance with the disclosure set forth below.

A technical device is therefore proposed, with which a pig that can be transferred onward from its pen is identified.

Identification refers generically to making a pig recognisable as being ready for onward transfer. Identification can be done in various ways, for example visually or acoustically or similar. In addition, the term “ready for onward transfer” must be distinguished from the term “ready for slaughter.” A pig may be ready for slaughter, for example, when it has reached its predetermined slaughter weight. However, it may not be ready for slaughter, even though it has reached its slaughter weight. Ready for onward transfer refers to whether a pig is to be transferred from its current pen. The reason for onward transfer can be different, for example, the pig is ready for slaughter and is to be transferred for slaughter, or the pig is to change its pen, or the pig is due for a veterinary visit and is therefore to be transferred onward, or similar. The term “ready for slaughter” and “ready for onward transfer” are therefore to be understood differently. For example, a pig that is ready for slaughter can be identified as ready for onward transfer if an animal transport is provided and the pig that is ready for slaughter can be transferred onward from its pen. If no animal transport is provided, a pig may be identified as not ready for onward transfer even though it has reached slaughter maturity, for example, because it cannot yet be transported onward. It is to be understood that transferral or turning out means to transfer or turn out the pigs from a pen or a rearing area.

The device for automated identification of the pig that is ready for onward transfer comprises a detection unit for the determination of weight statement for at least one pig. Thus, the device comprises a unit that is set up to determine the weight of at least one pig. The detection unit may, for example, be designed in the form of an optical camera system, as known from the prior art, or with electronic scales, or similar. The detection unit calculates or determines the weight of at least one pig. Here the wording at least identifies that the device can also be set up to detect or determine the weight of a number of pigs simultaneously. Detection can be generically understood as recording, or measurement, or similar. The weight statement is, for example, the current body weight of a specific pig whose weight is determined with the detection unit.

The device further comprises a database of pig-related data, whereby the pig-related data comprise statements concerning at least one specific or identifiable pig. The term pig-related data is based on the definition of personal data. Pig-related data thus comprise statements about at least one specific or identifiable pig. The pig-related data must therefore be unambiguously allocated to a specific pig. The pig-related data may also be referred to as pig data, and do not only physically characterise the pig; rather the pig-related data are all the data that are attributable to the specific pig. It is therefore proposed that a database of pig-related data is established and provided in which the pig-related data is stored in a retrievable manner. The database may be, for example, a local database at an agricultural livestock facility, or an external cloud database that is located outside the agricultural livestock facility. The database can also be understood as a data store or storage means.

The device further comprises an evaluation unit for the generation of an onward transfer indicator, whereby the evaluation unit is set up for the exchange of data with the detection unit and with the database. The evaluation unit is thus a technical unit in the form of hardware or software, which is set up to exchange data with, or at least receive data from, the detection unit and the database. The evaluation unit can also be understood to be an evaluation module. The evaluation unit may, for example, be part of a control unit of an agricultural livestock facility, or part of an external cloud computer unit. The evaluation unit is set up to receive the data or signals from the detection unit and the database. For this purpose, the evaluation unit may be connected to the detection unit and/or the database, for example via a communications interface. The evaluation unit generates an onward transfer indicator. An onward transfer indicator is an indicator that shows whether a pig is ready for onward transfer. The onward transfer indicator is therefore a technical means of indicating the state that in which pig can or should be transferred onward. The onward transfer indicator can be implemented in various ways, for example electronically, analogue, optically, or acoustically, or similar. An example of an electronic onward transfer indicator is a bit or data element with two states. An analogue onward transfer indicator is, for example, a printed designation of a particular pig on a list. A visual onward transfer indicator is, for example, a visual indicator that visually identifies a pig. An acoustic onward transfer indicator is, for example, an acoustic signal, for example, a computer-generated voice output, which can clearly be assigned to the pig to be transferred onward.

An essential aspect of the invention is that the evaluation unit generates the onward transfer indicator as a function of the determined weight value and as a function of the pig-related data, so as automatically to identify the pig with the onward transfer indicator as ready for onward transfer.

It is therefore proposed in accordance with the invention that in addition to the determined weight statement, the onward transfer indicator is generated as a function of the pig-related data. In contrast to the camera-based systems of known art, additional pig-related data is taken into account in order to identify the pig as ready for onward transfer. The solution in accordance with the invention thus creates a possibility of taking into account additional criteria or parameters for onward transfer by taking into account the additional pig-related data. The proposed device for the selection of pigs in an agricultural facility for pig breeding thus generates the selection decision not only on the basis of the weight of the pig, as known from the prior art; rather the selection decision also depends on additional parameters, namely at least on the pig-related data. In contrast to the systems of known art, this has the advantage that for example, waiting times or bottlenecks can be reduced during the onward transfer. The pigs are therefore only transferred onward from their pens or from their rearing area if they fulfil additional criteria besides the weight specification. Furthermore, the accuracy of the weight determination can be improved by the additional consideration of the pig-related data. It can happen, for example, that a weight is recorded incorrectly on the day of slaughter with the optical system. However, based on a comparison with the historical weight data from the pig-related data, it can be determined that the detected weight statement is not correct, and that the pig is still identified as ready for onward transfer. Also, for example, the pig-related data can include current position data of a particular pig, so that the pig that is next to be transferred onward is indicated to a transfer operator. This makes the onward transfer process more efficient. Further advantages arise depending on what pig-related data and what type of data are considered in the evaluation. A transfer operator is a person who transfers the pigs onward from the pens or from the rearing area. Transferral can also be understood as turning out.

The term device is to be understood here in particular as synonymous with the terms arrangement or system. In particular, individual, a number of, or all components of the device described here can be distributed, in particular spatially distributed, and/or can be detached or interconnected, in particular connected wirelessly, or by cable.

It is preferably proposed that the detection unit is an optical camera system, which is set up with an evaluation algorithm to determine a current weight value of the at least one pig, and/or whereby the detection unit is a set of scales, preferably electronic scales. The use of an optical camera system in combination with the additional consideration of pig-related data is particularly advantageous, since the onward transfer indicator is generated on the basis of image recognition and the pig data with a minimum of resources. The additional pig-related data can be used to implement an improved and more accurate weight determination with the evaluation algorithm. The optical camera system is, for example, designed with one or a number of cameras. The evaluation algorithm can also be understood as an algorithm for evaluating the image signal determined with the camera system. It is therefore proposed to use methods of image processing to determine the current weight value of the at least one pig, for example on the basis of distinctive points of the pig.

Using electronic scales as a detection unit in combination with the animal-related data is also an advantageous and preferred form of embodiment, as the scales determine the weight of the pigs in a robust and error-free manner. By additionally taking into account the pig-related data, an individual onward transfer for the pig can also be provided. Normally, scales only determine the weight of the animals, but no additional criteria. By additionally taking into account the animal-related data, a sick pig or an incorrectly fed pig can, for example, be identified on the scales as not ready for onward transfer, even though the pig's slaughter weight has already been reached. These and other possibilities to identify the pig as ready for onward transfer not only on the basis of the weight are only provided by the additional consideration of the pig-related data.

It is preferably proposed that the database is a cloud database and/or a local database with a cloud interface, whereby the local database is preferably set up to provide locally stored data to the evaluation unit in the event of a failure of the cloud interface. Thus, in both forms of embodiment, it is proposed that an interface to a cloud server is provided. A cloud database is a database that is external and provided externally to an agricultural facility, that is to say, it is not part of the agricultural livestock facility. Additionally or alternatively, it is proposed that a local database is implemented, but that the local database has a cloud interface to receive data from a cloud database. It is therefore proposed that the pig-related data is stored externally in the cloud. This is advantageous as the effort for the facility operator of the animal breeding facility is reduced, since the latter does not have to deal with data maintenance and data retention. In a particularly preferred form of embodiment, the local database is set up to store a part of the cloud database and provide it to the evaluation unit in the event of failure of the cloud interface. It is therefore proposed to keep a part of the cloud database locally in order to maintain correct operation, at least temporarily, in the event of a failure of the connections to the cloud database. This increases the security of the onward transfer process and ensures correct operation of the device, even in the event of failure of communication with the cloud database. The cloud database may, for example, be part of a cloud storage system or be understood as a cloud database system. Accordingly, the pig-related data is cloud data. The pig-related cloud data is provided for cloud computing or for building a cloud database. Cloud computing refers to the provision of computing services, including servers, storage, databases, networks, software, analytics, and intelligence, that are implemented or run on, or in, an external facility. An example of cloud computing is a software application implemented on a cloud computer or server that accesses a cloud database via a data interface through a query and receives cloud data delivered from the cloud database in response to the query, and processes the received cloud data in the software application. By taking cloud data and/or cloud processing into account, a better selection of animals to be transferred onward can be achieved. In particular, additional selection optimisations can be made by knowing the (life) history belonging to an animal ID. In this way, the data available via the cloud can be weighted, and/or, for example, factors can be weighted in a selection.

It is preferably proposed that the device is part of an agricultural livestock facility. An agricultural facility is understood to be, for example, a fattening farm, that is to say, a technical facility in the field of animal production, livestock management or livestock farming, in which farm animals are kept for the production of food and raw materials. In a particularly preferred form of embodiment, the agricultural facility is a facility for keeping pigs or for fattening pigs, in particular to produce slaughter material.

It is preferably proposed that the device further comprises a means of data acquisition for adding new pig-related data to the pig-related data in the database in order to update the pig-related data and/or to create a pig data history. It is therefore proposed that part of the device is an interface for entering new pig-related data. This interface can be understood as a data acquisition system.

It is preferably proposed that the weight determined with the detection unit is assigned to a corresponding animal on the basis of an animal identification or a unique identifier. A technical data assignment of the determined weight to the pig takes place. In this way, a weight history can be created and monitored.

It is particularly preferably proposed that the data acquisition system is a manual data acquisition system, for example a computer interface where the data is entered manually. Additionally or alternatively, the data acquisition system is a semi-automated data acquisition system, for example a scanning device with which pig-related data is read in, and/or the data acquisition system is a fully-automated data acquisition system, for example a camera-based system that can read out pig-related data on the basis of object recognition.

In a particularly preferred form of embodiment, the data acquisition system is set up to add new pig-related data to the database at regular time intervals, threshold-controlled, or event-controlled. It is therefore proposed to stream the pig-related data regularly into the data store. This will provide an up-to-date database. It has been found that good selection decisions for the harvesting of pigs are available when pig-related data are considered more frequently than every 2 hours, in particular more frequently than every 30 minutes, preferably, more frequently than every 10 minutes. At a lower upload frequency, the granularity of the data is too large to have a sufficiently broad database for the data required for the selection, since these have to be filtered and cleaned heavily in some cases due to the sensitivity of the evaluation mechanisms. From an upload interval of more than 120 minutes, other effects come to the fore. For example, a cloud update of once a day is too slow to recognise trends and thus too risky for any animal selection based on it. This data update frequency is particularly needed to filter out unwanted oscillating cycles and to suppress outliers in individual values.

It is preferably proposed that the pig-related data comprises the following statements from the list, namely at least one unique pig identification (ID) and one weight statement. It is therefore proposed that the pig-related data comprises at least a unique number or unique identification of the pig and its weight statement. By additionally taking into account the weight statement and the pig identification, for example in a camera-based system, the current weight value determined with the detection unit can be compared with the weight statement from the pig-related data. Accordingly, it is proposed to compare the measured and recorded weight statement with a stored weight statement to generate the onward transfer indicator. This makes the evaluation less error-prone.

Optionally, the pig-related data shall comprise at least one or more of the following:
a life span statement, in particular a birth date, or an age statement,
a generic statement,
one or more historical weight statements,
a food composition
a food intake statement,
an animal movement indicator
a fluid intake statement,
an animal health statement,
a medication statement,
an additive statement,
an illness statement,
an excretion statement,
a place of rearing statement,
a position statement to identify a location of the pig in an agricultural facility,
a behavioural statement,
a, or the, slaughter maturity indicator,
a deviation of a determined weight statement from a target weight,
an accuracy of the determined weight statement.

The following advantages are achieved: By taking into account the life span statement in addition to the determined weight, pigs that are too young can be identified as not ready for onward transfer, although their slaughter weight has already been achieved, or pigs that are too old and too light can be identified as ready for onward transfer. By taking into account the generic statement, pigs of different species can be kept at the same time, and only certain pigs of a certain genus can be indicated as ready for onward transfer on a day of slaughter. By taking into account historical weight statements, the weight determined by the detection unit can be verified. By taking into account the food composition, a check can be made as to whether a pig has actually ingested a predetermined food composition, and, for example, only pigs whose food composition complies with an organic certificate are transferred onward. By taking into account the food intake statement, it is possible to determine how weight correlates with food intake, and only pigs with a good or poor growth rate are transferred onward. For example, only pigs with a good growth rate can serve as breeding pigs. By taking into account the animal movement indicator, the weight can be correlated with the movement profile, and only pigs that have had sufficient movement, and can therefore be assumed to be of good meat quality, can be transferred onward. By taking into account the fluid intake indicator, it can be determined as to how weight correlates with the fluid intake indicator. By taking into account the animal health statement, only healthy and sufficiently heavy pigs can be transferred onward. By taking into account the medication statement, sufficiently heavy pigs that have only been administered certain medications in their lives can be transferred onward. Medication statements concern, for example, statements on performance enhancers, nutritional supplements, growth promoters, etc. By taking into account the additive statement, sufficiently heavy pigs can be identified as ready for onward transfer; those that have not taken any growth-promoting agents, for example. By taking the disease statement into account, sick but sufficiently heavy pigs can be prevented from being transferred onward. By taking into account the excretion statement, the health status of the pigs can be determined, and only healthy pigs can be transferred onward. By taking the rearing location statement into account, sufficiently heavy pigs of a certain origin can be identified as ready for onward transfer. By taking into account the position statement, a sufficiently heavy and locally closest pig can be indicated as being ready for onward transfer, and thus the onward transfer process can be designed more efficiently. By taking into account the behavioural statement, pigs with behavioural problems can be transferred onward. By taking into account a slaughter maturity indicator, it can be determined as to whether the weight of a pig correlates with slaughter maturity. By taking into account the deviation of the determined weight statement from a target weight, the currently recorded weight statement can be correlated with the deviation. By taking into account the accuracy of the determined weight statement, a pig whose determined weight is within the determined error tolerance can be transferred onward.

It is preferably proposed that the detection unit for the determination of the weight statement of the at least one pig is set up to estimate the weight statement of the pig by means of interpolation. It is therefore proposed that the detection unit is set up and designed to interpolate the weight statement of the pig. For this purpose, an interpolation algorithm or an interpolation function can be stored in the detection unit.

When using a camera-based detection unit as the detection unit, it is particularly preferably proposed that the detection unit is set up to estimate the weight statement of the pig by means of an interpretation of a number of images from different perspectives, or in a different temporal order. It is therefore proposed that the detection means records a number of camera images and interpolates the weight statement from the different angles so as to infer the weight, or that the detection means are set up to detect the weight at different times and then to interpolate between the different times to infer the weight.

It is preferably proposed that the evaluation unit for generating the onward transfer indicator is formed with an evaluation algorithm, whereby the evaluation algorithm is set up locally on a calculation unit of an agricultural livestock facility, and/or the evaluation algorithm is set up in a decentralised manner on a cloud computing device. It is therefore proposed that the evaluation algorithm is a local algorithm that is used in the agricultural livestock facility, or the evaluation algorithm is implemented in a decentralised manner on a cloud computing device.

In a particularly preferred form of embodiment, the evaluation algorithm is a machine learning algorithm, in particular an artificial neural network, or similar. It is to be understood that when using an artificial neural network, the artificial neural network has been trained in a training process based on labelled data to learn features that it is to recognise. Thus, a trained artificial neural network is proposed. Suitable machine learning algorithms include linear regression, logistic regression, support vector machine, random forest, Bayes classifier, least squares method, k-means algorithm, artificial neural networks, pattern recognition, or similar. Artificial neural networks can also be designated as artificial intelligence or Al.

It has been shown that with the very large variety of data related to pigs, this data is particularly suitable to be interpreted, improved, or accumulated, by Al. In order to reduce the amount of communication, processing external to the agricultural facility is preferred, in particular by means of cloud processing. In addition, results that are uploaded back to the cloud from the farm or slaughterhouse can be used as learning matrices for machine learning or ML. This enables even finer control of the target parameters.

An output value of the evaluation algorithm is preferably at least one, or the, onward transfer indicator. It is therefore proposed that the evaluation algorithm outputs the onward transfer indicator. For example, the artificial neural network described above may output the onward transfer indicator at an output node of the neural network. The neural network then, at least on an input layer, takes into account the animal-related data and the weight statement recorded by the detection unit.

It is preferably proposed that the device further comprises a display unit for displaying a pig that has been identified as ready for onward transfer with the onward transfer indicator, and whereby the display unit is set up to identify at least one pig as ready for onward transfer as a function of the generated onward transfer indicator. It is therefore proposed that part of the device is a display unit that displays or identifies the at least one pig that is ready for onward transfer, and has been identified with the onward transfer indicator. The display unit thus displays the identified pig, that is to say, the identified pig can be identified by way of the display unit. The display unit can be designed with different display means, which are described below.

In a particularly preferred form of embodiment, the display unit is a visual display unit or an acoustic display unit, that is to say, for example a terminal device on which the pig that is ready for onward transfer is displayed visually or, for example, a headset with a voice output. However, the optical display is not limited to a screen display, but can also be implemented in terms of a light source, or a printout, or similar. Optical thus generically refers to a visual perception. The acoustic display means correspondingly refers generically to an acoustic perception. For example, sounds, tones, or voice output, or similar, can be artificially generated.

This is advantageous, because the transfer operator can thus be informed by means of a communication mechanism, for example, optically or acoustically, as to which animal in which farm is to be transferred onward, from which barn, in which pen.

The indication device preferably comprises at least one display means for identifying pigs that are ready for onward transfer, whereby the display means is a display means from the list of display means comprising:
A mobile display means with a software program for computer-assisted augmentation of reality perception, preferably augmented reality spectacles, and/or a terminal device with a camera-based augmented reality application.
A swivelling spotlight, which is set up to identify a pig that is ready for onward transfer as ready for onward transfer by means of a light projection onto the pig, an infrared light projection is preferably generated with the spotlight, and further preferably the brightness of the light projection is adjusted as a function of an ambient light sensor. For this purpose, the swivelling spotlight may be designed to swivel in a number of axes and to generate the light projection by means of an illuminant and an optical system. In a further form of embodiment, a non-visible light is used for the technical device for visualisation to the human operator, that is to say, an infrared light projection is used. For example, the same identifier can be made by infrared light as with visible light, the transfer operator has a converter which shows him the infrared or IR identifier, for example, an appropriate pair of spectacles. This has the advantage that a visible light does not cause unrest in the pen and the stress level of the animals is therefore kept low.
A screen display, in which a pig that is ready for onward transfer is identified. The screen display can be, for example, a display of a terminal device, for example, of a computer, a tablet, a smartphone, or similar.
A list, in which a pig that is ready for onward transfer is listed. The list can be analogue or electronic, for example, it can be a printed list that is outputted from a printer, or an electronic list that is displayed on a terminal device.
A mobile display means, with which a pig that is ready for onward transfer is displayed, for example, a smartphone, a tablet, or similar.
A video projection system, that is set up to project a symbol onto the pig that is ready for onward transfer, for example, a semi-transparent screen, such as augmented reality spectacles, or a projector. If a user looks through the semi-transparent screen, the pig is identified with an identifier. However, a video projection system can also be a traditional projector.
A headphone unit with a voice output that acoustically reproduces an identification of a pig that is ready for onward transfer. For example, the name or a unique identification number of a pig can be output to a loudspeaker of a headphone in a computer-assisted manner.

The device preferably further comprises a position determination unit for the determination of the location of a pig in a rearing area of an agricultural livestock facility, and/or for the determination of the location of a person in the rearing area of the agricultural livestock facility. It is therefore proposed that a device is part of the device that is set up to determine the local position of a pig in the agricultural facility, or that of a person in the agricultural facility. By taking into account the local position of the pig or the person in the agricultural facility, it is advantageously achieved that this statement is available for optimising the onward transfer process. By taking into account the position of the pig and/or the person, for example, a pig that is closest to a person, that is to say, the transfer operator, can be identified as ready for onward transfer. In addition, by evaluating the position by means of an algorithm, the best possible order in which the pigs are to be transferred onward can be determined. This makes the onward transfer process more efficient. Thus, a selection or onward transfer of the animals to be transferred can take place on the basis of the weight and at least one additional criterion, whereby these are sorted in a favourable order, in particular if the animals finally have to be loaded in a certain order.

Preferably, the position determination unit for the determination of the location of the pig comprises a position determination unit from the list of position determination unit:
a camera system, which is set up to recognise the ear tags of pigs in the rearing area, in particular the ear tag includes an optically scannable code,
a camera system that is set up to identify an identifier applied to a pig by means of object recognition,
a locating system comprising a transmitter device and a receiver device, whereby the receiver device is located on the pig.

With regard to the camera system, it is therefore proposed to use the camera not only for weight detection, but also for position determination. The camera system is thus used for two functions, which enables resources for any additional measuring devices for position determination to be saved.

The identifier applied to a pig is, for example, a stamp, or a sprayed-on identifier.

The tracking system can be implemented using radio frequency identification or RFID technology, for example.

Air tags or their functional equivalents are preferably used for position determination. These are basically of known art.

Thus, an identification and positioning of individual animals is proposed, based, for example, on optical recognition features, or a triangulation based on radio waves, or, for example, on a permanent tracking of the animal's position by automatic tracking based on camera images.

By determining the position of the animals, the order of the animals can be sorted taking into account the current position of the animal, and an advantageous order can be determined and displayed.

The position determination for the determination of the location of a person in the rearing area of the agricultural facility is, more preferably, a camera-based person recognition with a person recognition algorithm, and/or a location system with a transmitter device and a receiver device, whereby the receiver device is set up on the person. It is therefore proposed not only to determine the location of the pigs, but also the transfer operators, that is to say, the persons who transfer the pigs. The position of the persons can then be used to optimise the onward transfer process.

The display unit with an evaluation module is preferably set up to display a sequence for the transfer of a number of pigs that are ready for onward transfer, whereby the sequence is determined as a function of the local position of the pigs determined with the position determination unit.

Additionally or alternatively, the display unit is set up to display the position of a pig that is ready for onward transfer, as determined by the position determination unit for the determination of the location of a pig.

The position determination unit is preferably set up to record continuously the position of the pig, and whereby the position determination unit is set up to store the recorded position as a position statement in the database, as pig-related data, so as to capture a movement profile.

The device preferably further comprises an additional data interface for receiving additional data of an electronic data processing or EDP system, whereby the evaluation unit for generating the onward transfer indicator is further set up to generate the onward transfer indicator as a function of the received additional data.

The additional data is preferably data from the list of data as follows:
a location position of a transfer operator, which is preferably determined with a, or the, position determination for the determination of a location of a person in the rearing area of the agricultural facility,
a transport capacity of a transport unit,
a total onward transfer quantity,
a time schedule.

The optical camera system is preferably designed as a number of cameras, each of which monitors a rearing area from a different direction, whereby the cameras are preferably high resolution cameras, with a resolution of at least 720p, and, more preferably, the number of cameras are set up to generate an interpolated weight estimate by means of a supervisory interpretation mechanism. Concerning the camera resolution of surveillance cameras, it is known that they need up to 100 pixels resolution per object to be able to undertake an object recognition, an object identification, or an object assignment. This shows that even with today's typical high-resolution cameras of 3840×2160 (higher resolutions would be associated with disproportionately large data traffic), a maximum of 10 objects (2000/(2*100)) can reliably be recognised in the vertical with uniform distribution and maximum contrast. Animals, however, are not evenly distributed, and therefore an interpretation per viewport is achieved by means of an algorithm based on a number of cameras with higher resolution per possible object; the viewport transitions are then adjusted in such a way that the number of animals and their positions is determined over an entire scene. This generates a higher reliability of the sensory data generated by the camera network when determining the weight. A viewport is an image area captured by a camera, and can also be understood to be a field of view or viewing area.

The device also preferably comprises at least one automated door unit, whereby the door unit is set up so as to change its opening state depending on the onward transfer indicator generated.

The device preferably also comprises a certificate generator that is set up to generate a certificate for a pig that has been identified as ready for onward transfer with the onward transfer indicator. It is therefore proposed that a certificate is generated for an animal that has been transferred onward, in particular a separate one for each individual animal. At the same time, on the basis of the cloud data, an assured property can be certified in terms of a proof. In particular, it can be ensured that the certificate confirms and/or quantifies the selection criteria. For the person skilled in the art, such certificates can also be created with a high degree of protection against forgery. In particular, a high degree of automation can prevent manual manipulation to a large extent. Such a certificate can also declare the accuracy of the respective values (for example, weight).

An implicit recognition of the onward transfer of the corresponding animal and corresponding registration is preferably proposed, for example, in terms of geo-tracking of the animal, or Al-based tracking by a camera.

A manual confirmation of the onward transfer, and corresponding registration, is preferably proposed. An onward transfer confirmation is preferably transacted locally, and additionally in the cloud, so as to provide redundancy.

A recalibration or supplementation of the pig-related data in the cloud memory is preferably proposed, based on further results, whereby the recalibration or supplementation is performed in particular with the aid of additional deep learning in artificial neural networks, and in particular data returned from slaughtering, and/or further processing of the animals, are added to the cloud data.

It is preferably proposed to generate a number of onward transfer indicators simultaneously with the evaluation unit in order to identify a number of pigs as ready for onward transfer at the same time.

It is preferably proposed that the evaluation unit is set up to determine a favourable sequence for the pigs with the onward transfer indicator.

In a particularly preferred form of embodiment, the detection unit is set up to receive images from a number of cameras and make a situational assessment. This is because larger facilities contain too many animals for this to be clearly recorded with a normal camera.

In another preferred form of embodiment, a number of cameras are used as detection units monitoring two rearing areas, between which animals may move. It is proposed that an overlapping area of the cameras is selected so that the object detection can interpret animals in the area of the overlapping zone. On the one hand, this can be achieved by both cameras being able to recognise the animals in the transition area, and then a supervisory system cuts out those that have been recognised twice, or on the other hand, it can be achieved by using only the results of both cameras (which then do not even have to overlap) in the supervisory system by means of a unified abstraction layer over the entire scene (for example, point cloud models with a conversion of the camera position-based local angles to absolute positions and, if necessary, a derived velocity, and/or [in the case of 3D cameras] distance) to carry out an object recognition, and thus also ‘half animals,’ which are only recorded by one camera, are transferred into an overall interpretation for a weight determination. In this way, the weight determination for the device is generated from the combinatorial interpretation (if necessary, by means of cloud computing) of the two primary sensors.

In another particularly preferred form of embodiment, the device is supplemented by the feature that a number of transfer operators work simultaneously on a harvesting procedure. This reduces the stress for the animals because they do not have to wait as long for onward transfer. The control system can also take into account the work progress and possibly the different working speeds of the transfer operators, and dynamically adjust the order of the animals, in particular taking into account the distances to be covered by the transfer operator.

In another particularly preferred form of embodiment, the device contains at least one camera as a detection unit, which is used for the weight determination, whereby this camera is additionally used for a further analysis of the animals. For example, activities of the animals can be monitored, or animal behaviour that is dependent on the barn climate can be detected. This dual use of the camera reduces the number of components in the pen, which in turn reduces the probability of failure, and thus increases the reliability of the overall system. A camera can also measure the barn brightness and can be used for brightness control of the lighting.

In another particularly preferred form of embodiment, the signalling brightness of the onward transfer indicator for a transfer operator is controlled on the basis of a local brightness determined by a camera. This means, for example, that places with direct sunlight can be illuminated more brightly than places in the shade. This leads to less stress for the animals during the harvesting procedure.

In another preferred form of embodiment, the change in weight of an animal between onward transfer and further processing (for example, slaughter) is predicted based on the available cloud data, and the selection decision is adjusted on the basis of this information. This leads to a more precisely definable weight at delivery. This form of embodiment is particularly efficient in the case of long transport journeys or intermediate barn accommodation.

In accordance with a further aspect of the invention, a method for automated identification of a pig that is ready to be transferred onward is proposed. The method comprises the steps of: determination of a weight statement of at least one pig with a detection unit; and generation of an onward transfer indicator with an evaluation unit, whereby the evaluation unit is set up for data exchange with the detection unit and with a database, and whereby pig-related data are stored in the database and the pig-related data comprise statements about at least one specific or identifiable pig, whereby the generation of the onward transfer indicator takes place as a function of the determined weight value and as a function of the pig-related data, in order to identify the pig automatically with the onward transfer indicator as ready for onward transfer.

It is preferably proposed that the detection unit and the evaluation unit and the database and the pig-related data and the onward transfer indicator proposed in the method are designed as described above for the device. For the method, reference is made to the explanations, definitions, and advantages of the device.

In accordance with a further aspect of the invention, a computer program product is disclosed, whereby the computer program product comprises instructions which, when the computer program product is executed by a computer, cause the computer to perform the steps of the method in accordance with any of the preceding or following forms of embodiment. Reference is made to all explanations, definitions, and advantages relating to the device and method described above.

In accordance with a further aspect of the invention, a computer-readable storage medium is disclosed, whereby the computer-readable storage medium comprises instructions which, when executed by a computer, cause the computer to perform the steps of the method in accordance with any of the preceding or following forms of embodiment. Reference is made to all explanations, definitions, and advantages of the device and method described above.

In accordance with a further aspect of the invention, a computer-readable data medium is disclosed, whereby the computer-readable data medium stores the computer program product in accordance with the above form of embodiment. Reference is made to all explanations, definitions, and advantages concerning the above-described device and method and the computer program product.

In accordance with a further aspect of the invention, a data medium signal is disclosed, whereby the data medium signal transmits the computer program product in accordance with the above form of embodiment. Reference is made to all explanations, definitions, and advantages concerning the above-described device and method and the computer program product.

The present invention is now explained in more detail below by way of examples of forms of embodiment with reference to the accompanying figures, whereby the same reference symbols are used for the same or similar assemblies:

### BRIEF DESCRIPTION OF THE DRAWINGS

FIG. 1 schematically shows a device in accordance with the invention for the automated identification of a pig that is ready for onward transfer;

FIG. 2 schematically shows a device for the automated identification of a pig that is ready for onward transfer in a further form of embodiment; and

FIG. 3 schematically shows a device for the automated identification of a pig that is ready for onward transfer in a further form of embodiment.

### DETAILED DESCRIPTION OF THE EMBODIMENTS

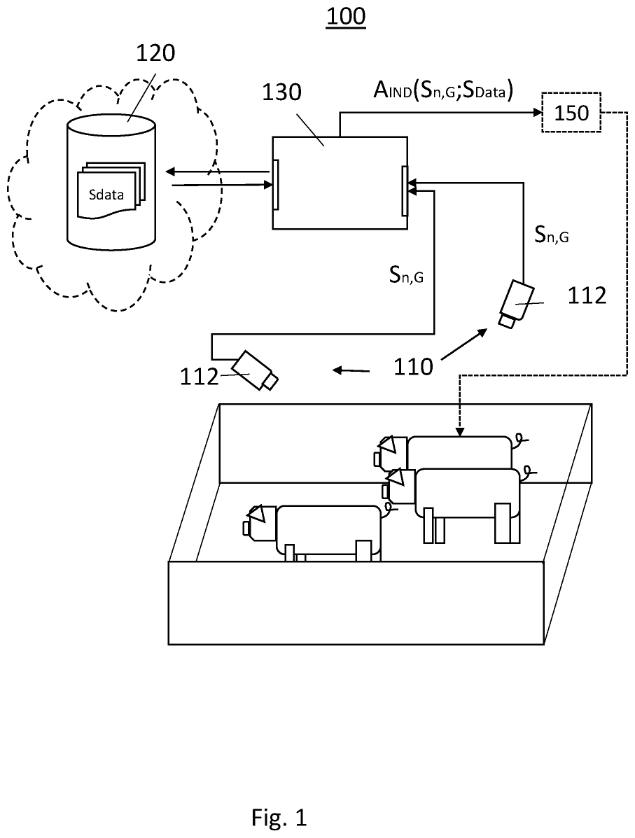

FIG. 1 shows a device 100 for the automated identification of a pig that is ready for onward transfer.

The device 100 comprises a detection unit 110 for the determination of a weight S_{n,G} of at least one pig. The detection unit 110 is, for example, a camera system consisting of two cameras 112 that optically monitor the pigs in a rearing area 172. The detection unit 110 can thus determine the three weights S_{1,G}, S_{2,G} and S_{3,G} of the three pigs shown in an exemplary manner.

The device 100 further comprises a database 120 containing pig-related data S_{Data}. The pig-related data S_{Data} comprises statements about at least one specific or determinable pig, for example the pig-related data of the three pigs shown. The device 100 further comprises an evaluation unit 130 for the generation of an onward transfer indicator A_{IND}, whereby the evaluation unit 130 is set up to exchange data with the detection unit 110 and with the database 120. The evaluation unit 130 generates the onward transfer indicator A_{IND} as a function of the determined weight value S_{n,G} and as a function of the pig-related data S_{Data}, in order to identify automatically at least one of the three pigs with the onward transfer indicator A_{IND} as being ready for onward transfer. The dependence of the onward transfer indicator A_{IND} is also illustrated by the bracketed expression A_{IND} (S_{n,G};S_{Data}) in FIG. 1. The pig-related data may include various statements about the pigs as described above.

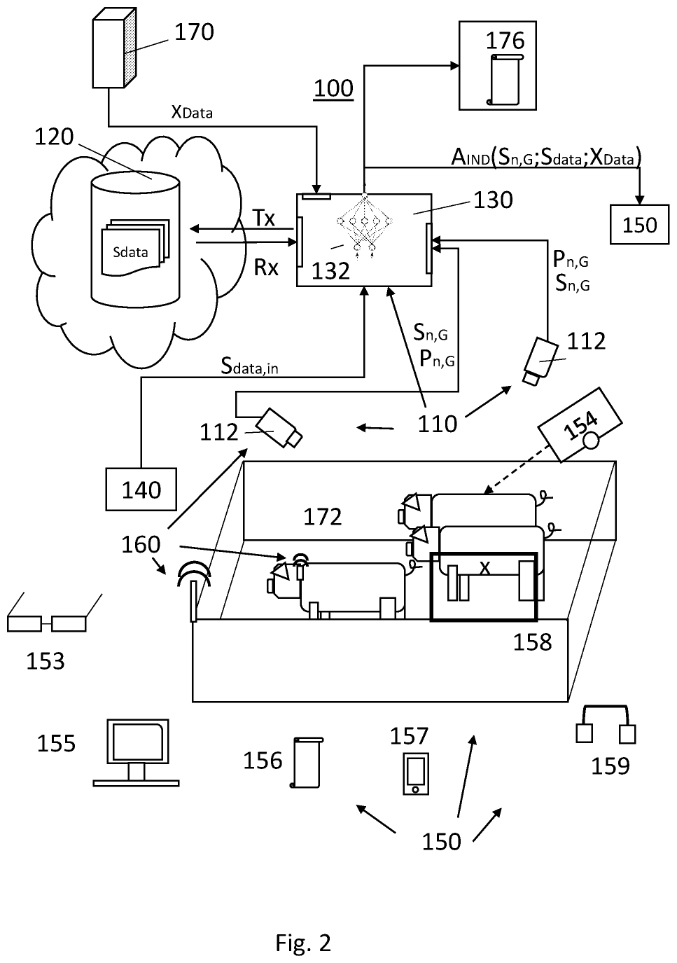

FIG. 2 shows various particular forms of embodiment of the generic device as shown in FIG. 1.

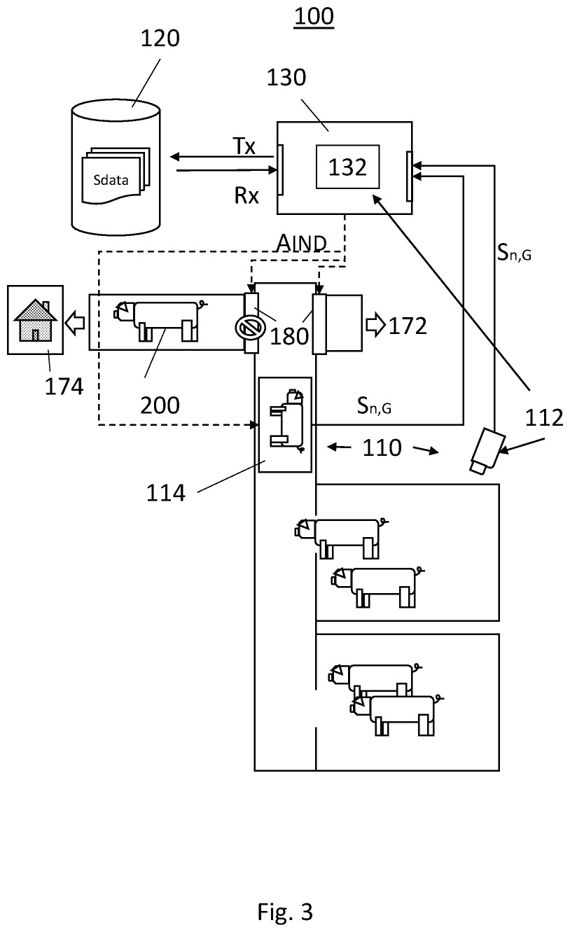

It is shown that the detection unit 110 can be designed as an optical camera system 112, which is set up with an evaluation algorithm 132 to determine a current weight value of the at least one pig. In addition, the detection unit 110 can also be designed as a set of scales 114, as shown in FIG. 3.

It is also shown that database 120 is a cloud database, as illustrated by the symbolic cloud.

The device 100 is part of an agricultural livestock facility, namely an agricultural facility for keeping or breeding pigs, which is illustrated by the three pigs standing in a pen.

It is also shown that the device 100 further comprises a data acquisition system 140 by means of which new pig-related data S_{Data}, in added to the pig-related data in the database 120 to update the pig-related data S Data and create a pig data history.

The data acquisition system 140 is only schematically shown as a block 140, but may be a manual data acquisition system, and/or a semi-automated data acquisition system, and/or a fully automated data acquisition system. The data acquisition 140 is set up to add new pig-related data S_{Data,in} at regular time intervals, or event-driven, to the database 120.

As can be seen in FIG. 2, the evaluation module 130 is connected to the database 120 via an interface. Data is transmitted to the database 120, or data call requests are sent to the database 120 via a send connection TX. Data is received from database 120 via a receive connection RX. The communication paths illustrated with arrows are only exemplary and the data acquisition system 140 could also communicate directly with the database 120, for example. The arrows in FIG. 2 illustrate in principle the direction of the data or signal connection.

It is also shown in FIG. 2 that the detection means 110 for the determination of the weight of the at least one pig is set up to estimate the weight of the pig by interpolation, whereby the camera-based detection means 112 shown is set up to estimate the weight of the pig by interpreting a number of images from different perspectives. As can be seen in FIG. 2, the two cameras 112 are oriented differently and capture a different area of the rearing area 172.

It is also shown that the evaluation unit 130 for generating the onward transfer indicator is formed with the evaluation algorithm 132, whereby the evaluation algorithm 132 is set up locally on a calculation unit of an agricultural livestock facility and the evaluation algorithm 132 is a machine learning algorithm, namely an artificial neural network.

The device 100 may further comprise a display unit 150 for displaying a pig identified as ready for onward transfer by the onward transfer indicator A_{IND}, whereby the display unit 150 is set up to identify at least one pig as ready for onward transfer as a function of the generated onward transfer indicator A_{IND}. The indication device is a visual indication device 153 to 157 or an acoustic indication device 159.

The display unit 150 has at least one display means 153 to 157 for the identification of pigs that are ready for onward transfer, whereby the display means as shown are: A mobile display means 153, 157 with a software program for computer-assisted augmentation of reality perception, namely augmented reality spectacles 153, and/or a terminal device 157 with a camera-based augmented reality application; a swivelling spotlight 154 set up to identify a pig that is ready for onward transfer as ready for onward transfer by means of a light projection onto the pig, a screen display 155 in which a pig that is ready for onward transfer is identified, a list 156 in which a pig that is ready for onward transfer is listed; a mobile display means 157 for displaying a pig that is ready for onward transfer; a video projection system 158 set up to project a symbol X onto the pig that is ready for onward transfer; and a headphone unit 159 having a voice output for audibly reproducing an identification of a pig that is ready for onward transfer.

FIG. 2 also illustrates that a position determination unit 112, 160 for locating a pig in a rearing area of an agricultural livestock facility, and/or for locating a person in the rearing area of the agricultural livestock facility.

Here is shown a position determination unit formed with a camera system 112, which is set up to detect the ear tags of pigs in the rearing area that recognise an optically scannable code on an ear tag, and a locating system 160 with a transmitter device and a receiver device is also shown, whereby the receiver device is set up on a pig.

In addition, FIG. 2 shows an additional data interface for receiving additional data X_{Data} from a computer system 170, whereby the evaluation unit 130 for generating the onward transfer indicator A_{IND} is additionally set up to generate the onward transfer indicator A_{IND} as a function of the additional data received.

The optical camera system 112 is designed as a number of cameras, each monitoring a rearing area 172 from different directions, whereby the cameras are high resolution cameras having a resolution of at least 720p, and the number of cameras are set up to generate an interpolated weight estimate by means of a higher-level interpretation mechanism.

In addition, a certificate generator 176 is shown, which is set up to generate a certificate for a pig that has been identified as ready for onward transfer by the onward transfer indicator.

FIG. 3 shows a device 100 for the automated identification of a pig that is ready for onward transfer, with a detection unit 112, 114 for the determination of a weight value of at least one pig, a database 120 with pig-related data S_{Data}, whereby the pig-related data comprise statements about at least one determined or determinable pig, and an evaluation unit 130 for generating an onward transfer indicator A_{IND}, whereby the evaluation unit is set up for the exchange of data with the detection unit 110 and with the database 120, and the evaluation unit 130 generates the onward transfer indicator A_{IND} as a function of the determined weight value S_{n,G} and as a function of the pig-related data S_{Data}, in order to identify automatically the pig with the onward transfer indicator as being ready for onward transfer.

The detection unit 110 is designed as an optical camera system 112, which is set up with an evaluation algorithm 132 so as to determine a current weight value of the at least one pig, and the detection unit 110 further comprises electronic scales 114.

In addition, FIG. 3 shows at least one automated door unit 180, whereby the door unit 180 is set up to change its opening state depending on the generated onward transfer indicator. For example, a pig that passes over the scales 114 can be transferred onward individually by additionally taking into account the pig-related data. For example, a healthy pig 200 can be transferred onward to the slaughterhouse 174 or onward transfer, and an unhealthy pig or improperly fed pig 202 can be transferred back to a rearing area 172.

1.-22. (canceled)

23. (canceled)

24. A device for the automated identification of a pig that is ready for onward transfer, comprising:
a detection unit for the determination of a weight statement of at least one pig;
a database with pig-related data (S_{Data}), wherein the pig-related data comprise statements concerning at least one specific or identifiable pig; and
an evaluation unit configured to generate an onward transfer indicator (A_{IND}), wherein the evaluation unit is configured for data exchange with the detection unit and with the database:
wherein the evaluation unit generates the onward transfer indicator (A_{IND}) as a function of the determined weight value (S_{n,G}) and as a function of the pig-related data (S_{Data}) so as automatically to identify the pig with the onward transfer indicator as ready for onward transfer.

25. The device according to claim 24, wherein:
the detection unit is an optical camera system, which is configured with an evaluation algorithm so as to determine a current weight value (S_{n,G,akt}) of the at least one pig; and/or
the detection unit is a set of electronic scales.

26. The device according to claim 24, wherein the database is a cloud database and/or a local database with a cloud interface, wherein the local database is configured to provide locally stored data to the evaluation unit in the event of a failure of the cloud interface.

27. The device according to claim 24, wherein the device is part of an agricultural livestock facility.

28. The device according to claim 24, wherein:
the device further comprises a data acquisition system, by which new pig-related data (S_{Data,in}) is added to the pig-related data in the database in order to update the pig-related data (S_{Data}), and/or to create a pig data history; and
the data acquisition system is a manual data acquisition system, a semi-automated data acquisition system, and/or a fully automated data acquisition system; and
the data acquisition system is further configured to add new pig-related data to the database at regular intervals or on an event-driven basis.

29. The device according to claim 24, wherein:
the pig-related data (S_{Data}) comprises the following statements from a list of statements, namely at least one unique pig identifier (S_{ID}) and a weight statement, and optionally the pig-related data comprises at least one or more of the following statements:
a life span statement, comprising a birth date or an age statement;
a generic statement;
one or a number of historical weight statements;
a food composition;
a food intake statement;
an animal movement indicator;
a fluid intake statement;
an animal health statement;
a medication statement;
an additive statement;
an illness statement;
an onward transfer statement;
a rearing location statement;
a position statement to identify a location of the pig in an agricultural facility;
a behavioural statement;
a slaughter maturity indicator;
a deviation of a determined weight from a target weight; and/or
an accuracy of the determined weight statement.

30. The device according to claim 29, wherein:
the detection unit for the determination of the weight statement of the at least one pig is configured to estimate the weight statement of the pig by means of interpolation when using a camera-based detection unit, and the detection unit is configured to estimate the weight statement of the pig by means of an interpretation of a number of images from different perspectives or in a different temporal order.

31. The device according to claim 24, wherein:
the evaluation unit for generating the onward transfer indicator is configured with an evaluation algorithm;
the evaluation algorithm is configured locally on a calculation unit of an agricultural livestock facility and/or the evaluation algorithm is configured decentrally on a cloud computer device; and
the evaluation algorithm is a machine-learning algorithm comprising an artificial neural network, and an output value of the evaluation algorithm is at least an, or the, onward transfer indicator.

32. The device according to claim 24, further comprising:
a display unit for the display of a pig, which is identified as ready for onward transfer by means of the onward transfer indicator, wherein the display unit is configured to identify at least one pig as ready for onward transfer as a function of the generated onward transfer indicator, and the display unit is a visual display unit or an acoustic display unit.

33. The device according to claim 32, wherein the display unit comprises at least one display for the identification of pigs that are ready for onward transfer, wherein the display comprises one of the following:
a mobile display with a software program for computer-assisted augmentation of reality perception, including augmented reality spectacles and/or a terminal device with a camera-based augmented reality application;
a swivelling spotlight configured to identify a pig that is ready for onward transfer as ready for onward transfer by means of a light projection onto the pig;
an infrared light projection configured to be generated with the swivelling spotlight, wherein the brightness of the light projection may be adjusted as a function of an ambient light sensor;
an on-screen display in which a pig that is ready for onward transfer is identified;
a list, in which a pig that is ready for onward transfer is listed;
a mobile display with which a pig that is ready for onward transfer is displayed;
a video projection system configured to project a symbol onto the pig that is ready for onward transfer; and/or
a headphone unit with a voice output that acoustically reproduces an identification of a pig that is ready for onward transfer.

34. The device according to claim 24, further comprising a position determination unit for the determination of the location of a pig in a rearing area of an agricultural livestock facility, and/or for the determination of the location of a person in the rearing area of the agricultural livestock facility, the position determination unit for the determination of the location of the pig comprising:
a position determination unit from a list of determination units:
a camera system configured to recognise the ear tags of pigs in the rearing area, wherein the ear tag includes an optically scannable code;
a camera system configured to identify an identifier applied to a pig by means of object recognition; and/or
a tracking system with a send unit and a receive unit, wherein the position determination for the determination of the location of the pig is the receive unit located on the pig and the position determination for the determination of the location of a person in the rearing area of the agricultural facility is a camera-based person recognition with a person recognition algorithm and/or a tracking system with a send unit and a receive unit, wherein the receive unit is located on the person.

35. The device according to claim 34, further comprising a display unit comprising an evaluation module configured to display a sequence for the transfer onward of a number of pigs that are ready for onward transfer, wherein:
the sequence is determined as a function of the location of the pigs as determined with the position determination unit; and/or
the display unit is configured to display the location of a pig that is ready for onward transfer as determined by the position determination unit for the determination of the location of a pig.

36. The device according to claim 34, wherein:
the position determination unit is configured to record continuously the position of the pig: and
the position determination unit is configured to store the recorded position as a position statement in the database as pig-related data, to record a movement profile.

37. The device according to claim 24, further comprising an additional data interface for receiving additional data (X_{Data}) from a computer system, wherein the evaluation unit for generating the onward transfer indicator (A_{IND}) is configured to generate the onward transfer indicator as a function of the received additional data, where the additional data comprises data from a list of data including:
a location position of a transfer operator determined with a position determination for the determination of the location of a person in a rearing area of an agricultural facility;
a transport capacity of a transport unit;
an onward transfer total quantity; and
a time schedule.

38. The device according to claim 25, wherein:
the optical camera system is configured as a plurality of cameras each monitoring a rearing area from different directions; and
the plurality of cameras are high resolution cameras with a resolution of at least 720p, and plurality of cameras are configured to generate an interpolated weight estimate via a higher-level interpretation mechanism.

39. The device according to claim 24, further comprising at least one automated door unit, wherein the automated door unit is configured to alter its opening state as a function of the generated onward transfer indicator.

40. The device according to claim 24, further comprising a certificate generator configured to generate a certificate for a pig that has been identified as ready for onward transfer with the onward transfer indicator.

41. A method for the automated identification of a pig that is ready for onward transfer, the method comprising the steps of:
determination of a weight statement for at least one pig with a detection unit; and
generation of an onward transfer indicator with an evaluation unit;
wherein the evaluation unit is configured for data exchange with the detection unit and with a database; and
wherein pig-related data are stored in the database and the pig-related data comprise statements concerning at least one specific or identifiable pig, such that the generation of the onward transfer indicator takes place as a function of the determined weight value and as a function of the pig-related data to automatically to identify the pig with the onward transfer indicator as ready for onward transfer.

42. A computer program product, comprising instructions, which, when the computer program product is executed by a computer, causes the computer to perform the steps of claim 41.

43. A computer-readable storage medium, comprising instructions, which, when executed by a computer, cause the computer to execute the steps of the method of claim 41.

44. A computer-readable data medium, on which the computer program product according to claim 42 is stored.

45. A data medium signal, which transmits the computer program product according to claim 42.
